(19) United States
(12) Patent Application Publication
(10) Pub. No.: US 2015/0274547 A1
(43) Pub. Date: Oct. 1, 2015

(54) POROUS METAL CERAMIC MATERIALS AND METHODS FOR MAKING AND USING THE SAME

(71) Applicant: UNIVERSITY OF VIRGINIA PATENT FOUNDATION, Charlottesville, VA (US)

(72) Inventors: James A. Smith, Charlottesville, VA (US); Beeta Ehdaie, Charlottesville, VA (US); Carly Krause, San Francisco, CA (US)

(73) Assignee: University of Virginia Patent Foundation, Charlottesville, VA (US)

(21) Appl. No.: 14/440,685

(22) PCT Filed: Nov. 5, 2013
(86) PCT No.: PCT/US2013/068409

§ 371 Date: May 5, 2015

Related U.S. Application Data
(60) Provisional application No. 61/722,352, filed on Nov. 5, 2012.

(51) Int. Cl. C02F 1/28; C02F 1/00; A01N 25/08; A01N 59/16; A01N 59/20; C02F 1/50; C02F 1/42

(52) U.S. Cl. CPC C02F 1/281; C02F 1/505; C02F 1/003; C02F 1/42; C02F 1/288; A01N 59/16; A01N 59/20; A01N 25/08; C02F 2307/04; C02F 2303/04

(57) ABSTRACT

Aspects of the invention include porous ceramic materials and methods of preparing and using the same. The porous ceramic material may include a three-dimensional porous structure of fused clay ceramic and metal nanopatches. In some cases, the methods include providing a mixture including clay, a pore-forming agent, and a metal ion-containing component and heating the mixture under conditions sufficient to sinter the clay and the metal ion-containing component thereby forming a porous metal ceramic material. The pore-forming agent may be removed by combustion during heating. In some embodiments, the metal ion is silver, copper, or a mixture thereof. Also provided are methods of disinfecting a water source using the subject materials. Aspects of the invention further include compositions, e.g., materials, water treatment devices and kits, etc., that find use in methods of the invention.

### CROSS REFERENCE TO RELATED APPLICATIONS

This application claims priority under 35 U.S.C. §119(e) to U.S. provisional patent application No. 61/722,352, filed Nov. 5, 2012, the disclosure of which is hereby incorporated by reference.

### INTRODUCTION

In industrialized countries like the United States, centralized water treatment plants commonly provide high-quality drinking water with chlorine residuals that are delivered directly to the taps of households. In the developing world, many communities cannot afford this significant infrastructure. As a result, billions of people globally lack access to consistently safe, high-quality drinking water.

Safe, high-quality drinking water is relevant to a range of health issues. For example, HIV-positive individuals are particularly susceptible to infections from waterborne pathogens, because HIV-positive subjects may have weakened immune system. The World Health Organization has recently suggested that a decentralized approach to water treatment may be a better solution to water quality problems in the developing world. They have suggested that “point-of-use” water treatment technologies, wherein water is purified in the household just before it is consumed, can be an effective way to provide safe water.

Thus, point-of-use water disinfection or filtration materials and methods are of interest. Technologies of interest include those that are economical and make use of local materials.

There is a long felt need in the art for compositions and methods that can be economically and easily prepared and made to disinfect contaminated water, particularly drinking water. The present invention satisfies these needs.

### SUMMARY

Aspects of the invention include porous metal ceramic materials and methods of preparing and using the same. The porous ceramic metal material may include a three-dimensional porous structure of sintered clay and metal nanopatches. The metal nanopatches are areas of zerovalent metal that may be distributed throughout the porous structure of the ceramic. In some cases, the methods of preparation include providing a mixture including a clay component, a pore forming agent and a metal ion-containing component and heating the mixture under conditions sufficient to sinter the clay and the metal ion-containing component thereby forming a porous metal ceramic material. In some embodiments, the metal is silver, copper, or a mixture thereof. Also provided are methods of disinfecting a water source using the subject porous metal ceramic material. Aspects of the invention further include compositions, e.g., materials, water treatment devices and kits, etc., that find use in methods of the invention.

### BRIEF DESCRIPTION OF THE DRAWINGS

The invention is best understood from the following detailed description when read in conjunction with the accompanying drawings. The patent or application file contains at least one drawing executed in color. Copies of this patent or patent application publication with color drawing(s) will be provided by the Office upon request and payment of the necessary fee. It is emphasized that, according to common practice, the various features of the drawings are not to-scale. On the contrary, the dimensions of the various features are arbitrarily expanded or reduced for clarity. Included in the drawings are the following figures.

FIG. 1 depicts a water treatment device (100) that includes a porous metal ceramic tablet (102). The water treatment device depicted includes a first chamber (110) with an inlet (112) and an outlet filter (e.g., 108) fluidically connected (via 108) to a reservoir (104) having an outlet valve (106).

FIG. 2 shows a graph of controlled release of silver from a porous metal ceramic tablet including 50 mg silver into 200 mL distilled water.

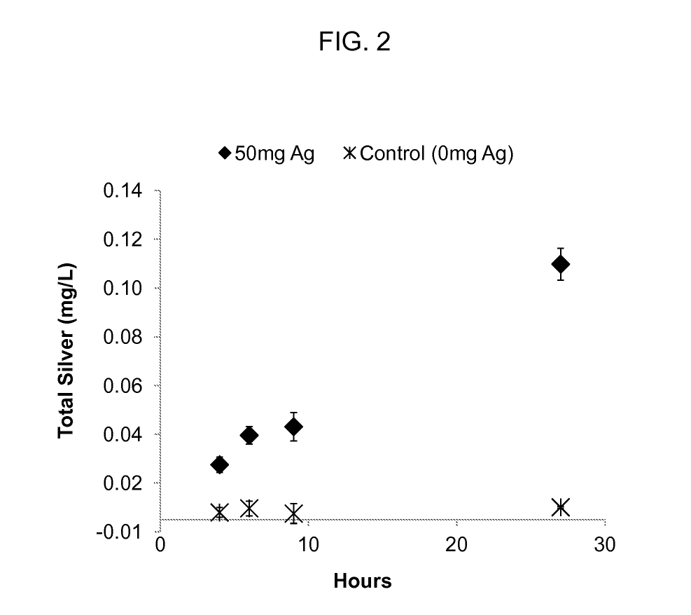

FIG. 3 shows a graph of reduction in E coli in water incubated for up to 30 hours with a porous metal ceramic tablet (also referred to herein as a “MadiDrop”) including 50 mg silver versus a control tablet.

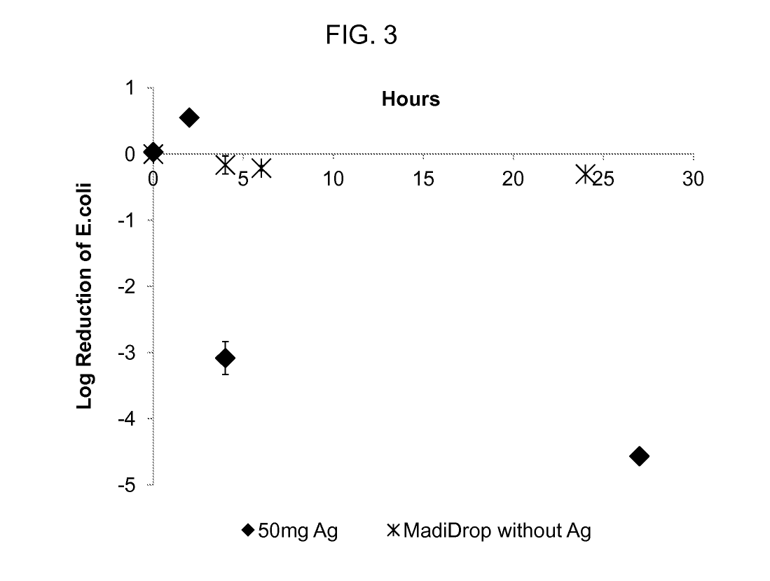

FIG. 4 depicts a transmission electron microscope (TEM) image showing zerovalent silver nanopatches (e.g., of 7 nm, 6 nm and 17 nm diameters) on and throughout a porous ceramic material. The MadiDrop was made with flour and 500 mg of silver nitrate. See also FIG. 16, which graphically depicts associated energy spectroscopy (EDS) data for silver nanopatches identified on the ceramic surface of a tablet of FIG. 4.

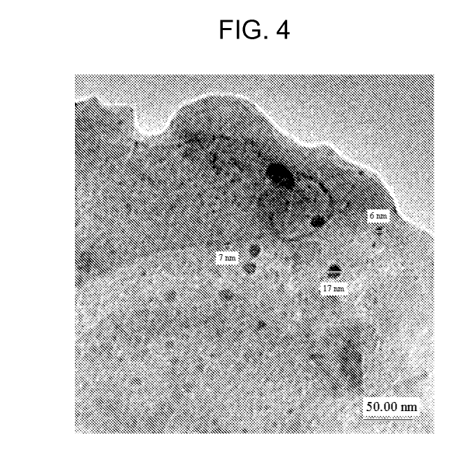

FIG. 5 shows a graph of ionic silver versus total silver released into residual water incubated with a tablet (81 water samples each incubated with a tablet). Each sample's ionic and total silver measurement was compared to show that the silver being released from the tablet is in ionic form. Data indicate that essentially 100% of silver release under these conditions is ionic silver.

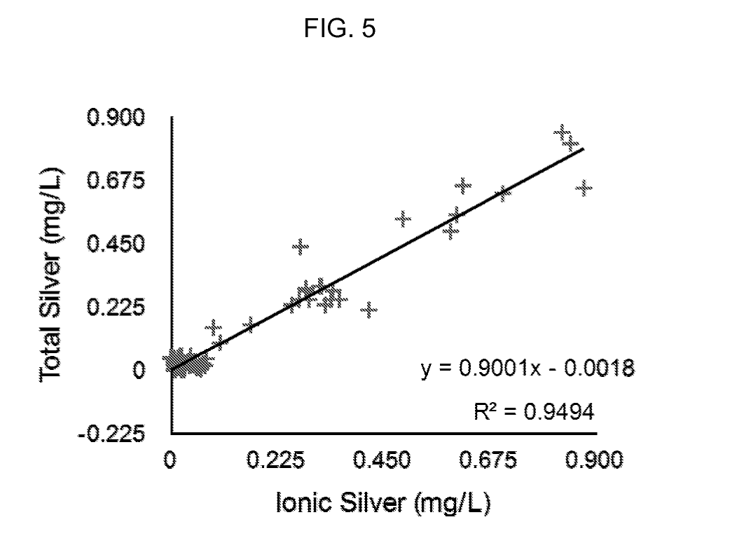

FIG. 6 shows at top a graph of release of silver from tablets including 50 mg or 500 mg silver into 200 mL distilled water; and at bottom a graph of reduction in E. coli in water incubated with a tablet including 50 mg or 500 mg silver versus a control tablet.

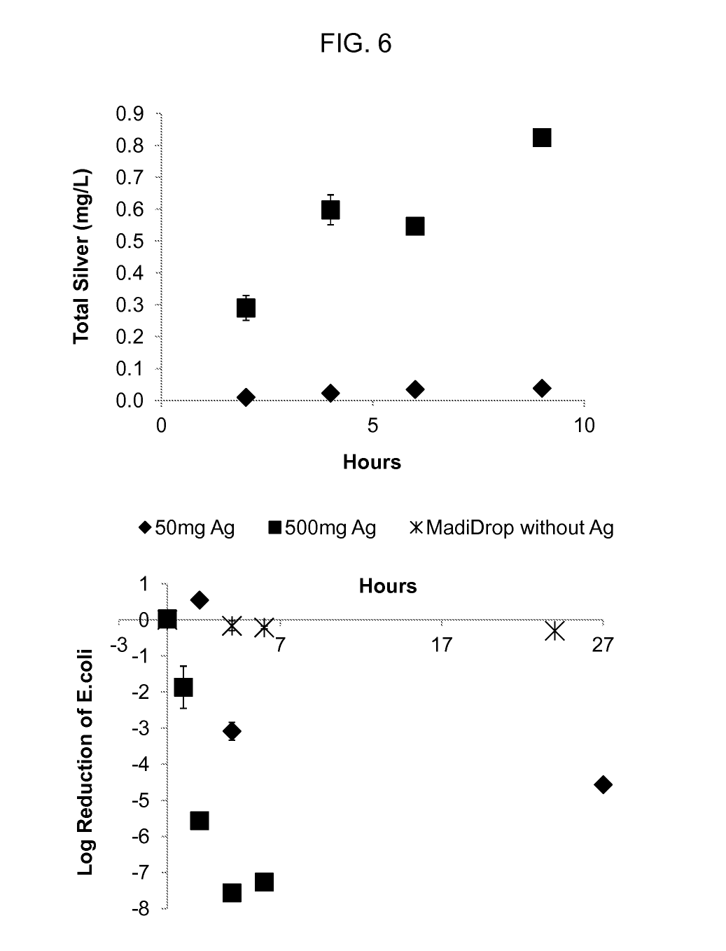

FIG. 7 shows a graph of release of silver over time from various tablets prepared from mixtures of 0 to 20 weight percent of pore-forming agent (e.g., sawdust passed though a 20-mesh sieve) to clay. Tablets were made with an initial mass of 50 mg of silver. Measurements were normalized to control tablets that did not have any silver. Experiments were conducted in 200 ml of water.

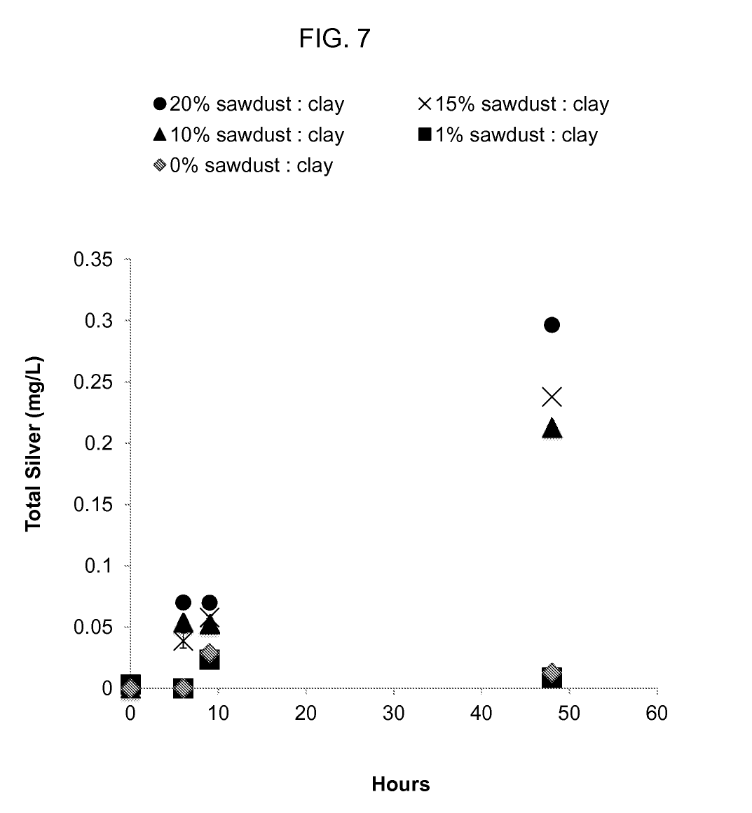

FIG. 8 shows a graph of reduction in E. coli in water incubated with tablets prepared from mixtures of 10 to 20 weight percent of pore-forming agent (e.g., sawdust passed though a 20-mesh sieve) to clay (see FIG. 7). Tablets were made with an initial mass of 50 mg of silver. Measurements were normalized to control tablets that did not have any silver. Experiments were conducted in 200 ml of 10 mM phosphate buffer.

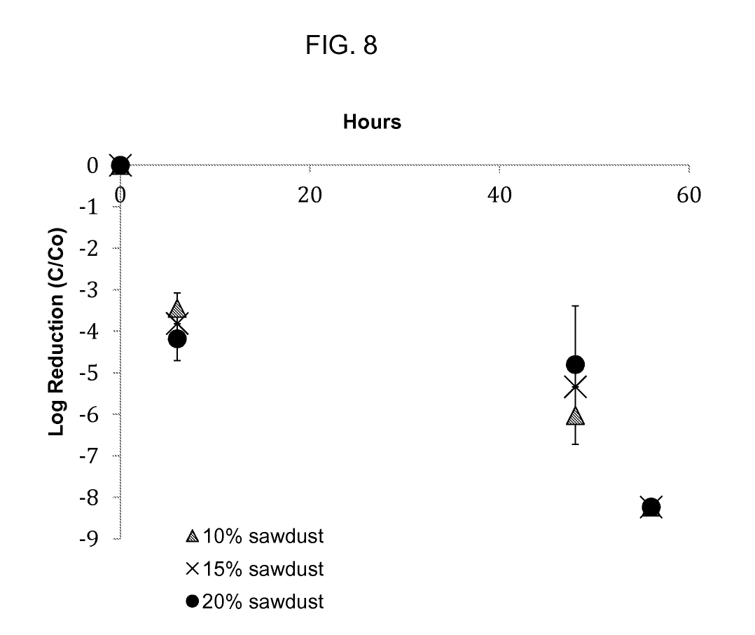

FIG. 9 shows a graph of release of silver over time into water incubated with tablets prepared from mixtures of 10 weight % pore-forming agent (e.g., sawdust) to clay, where the pore-forming agent is a particulate material passed through either a 30 mesh, 20 mesh or 16 mesh sieve. All tablets were embedded with 50 mg of silver. The measurements were normalized to control tablets that did not have any silver in them. Experiments were conducted in 200 ml of water.

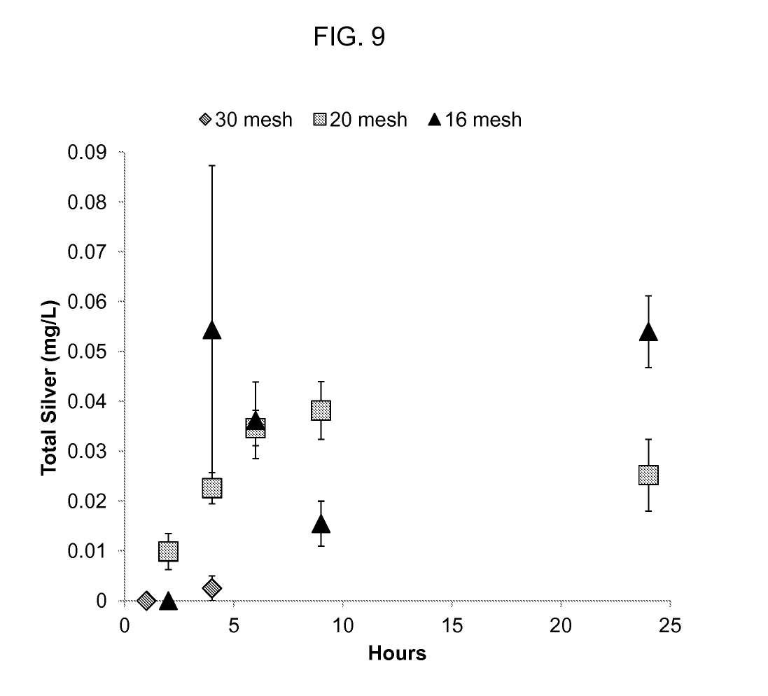

FIG. 10 shows a graph of release of silver over time into water incubated with tablets prepared from a variety of sawdust pore-forming agents and clays. Tablets were made with 50 mg of silver. Measurements were normalized to control tablets that did not have any silver. Experiments were conducted in 200 ml of 10 mM phosphate buffer. The same tablets were used in FIG. 11.

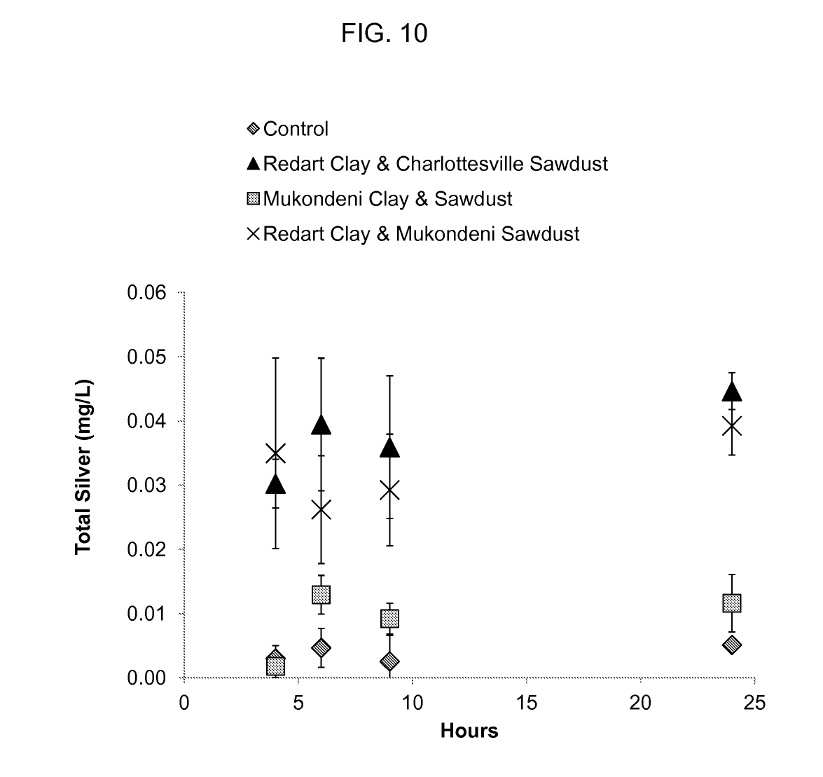

FIG. 11 shows a graph of reduction in E. coli in water incubated with tablets prepared from a variety of mixtures of sawdust pore-forming agents and clays. Tablets were made with 50 mg of silver. Measurements were normalized to control tablets that did not have any silver. Experiments were conducted in 200 ml of 10 mM phosphate buffer.

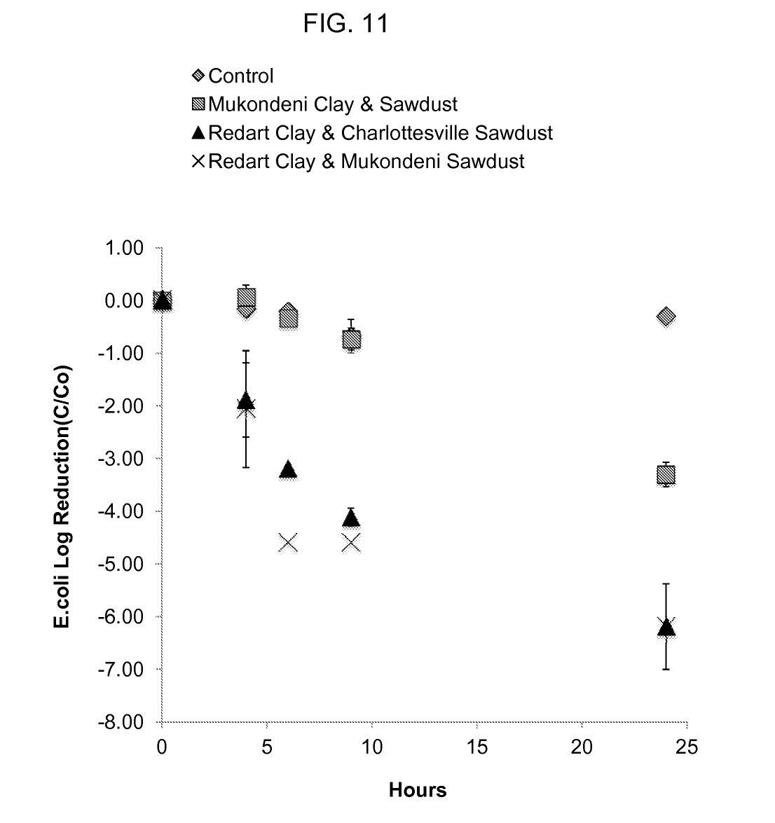

FIG. 12 shows a graph of release of silver over time into water incubated with 1 g silver tablets of different sizes, 65 mm diameter×10 mm, 65 mm diameter×30 mm, 65 mm diameter×45 mm and 130 mm diameter×7 mm. The tablet with 3× the volume released a sufficient amount of silver for disinfection of 10 L when embedded with 1 g of Ag. The silver release rate is a controlled, steady-state release so that silver levels in the water remain below the drinking water standard.

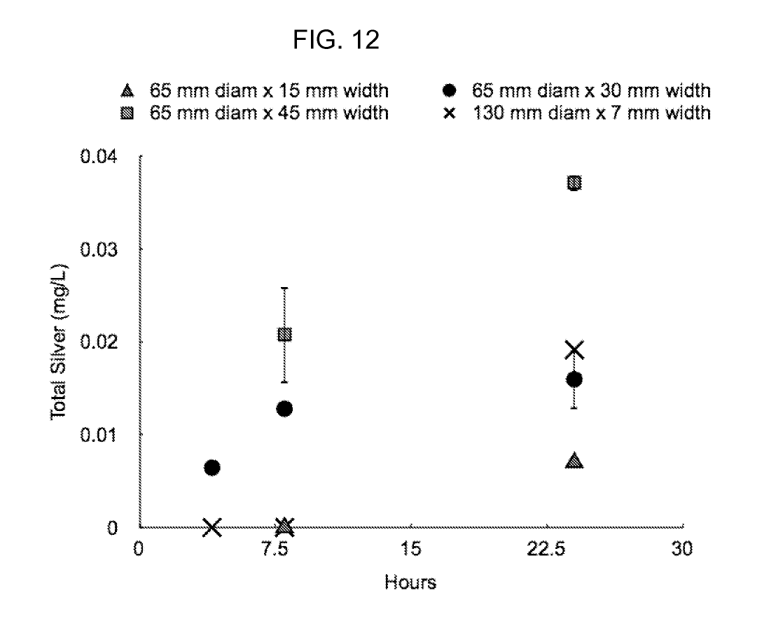

FIG. 13 shows a graph of reduction of E. Coli in water incubated with a 65 mm diameter×45 mm width 1 g silver tablet.

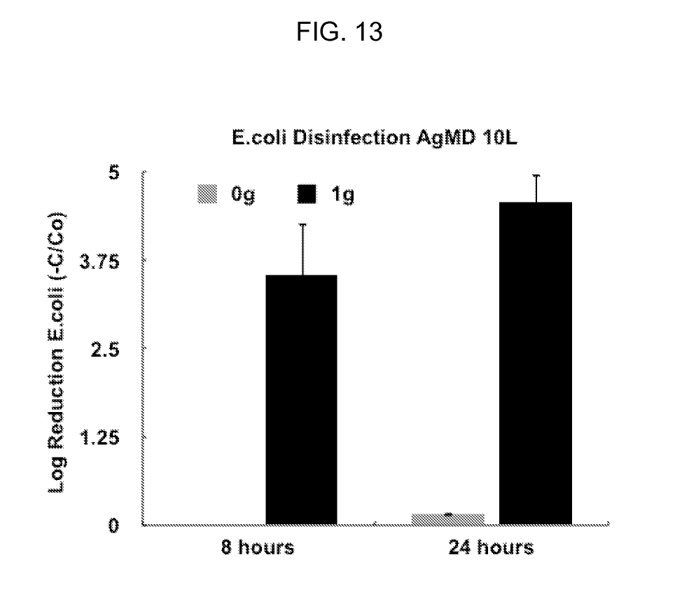

FIG. 14 depicts cross-sectional (top) and perspective (bottom) views of water treatment devices that include a chamber (204), a porous metal ceramic material (202), and two ports (206 and 208) that serve as inlets or outlets. The chamber of the device may be open or closed system, e.g., have an open top (see bottom) or a closed top.

FIG. 15 graphically depicts copper release from copper nitrate embedded ceramic tablets. Tablets were made with 10% sawdust (20 mesh sieve) and redart clay. Tablets were embedded with varying concentrations of copper (50, 500, 1,000 and 2000 mg) and pressed into 65 mm diameter×15 mm width disk shape. Ceramic tablets were placed in 200 mL of deionized water. Total copper levels were measured using the atomic absorption spectrometer. The ordinate represents total copper in mg/L and the abscissa represents time in hours.

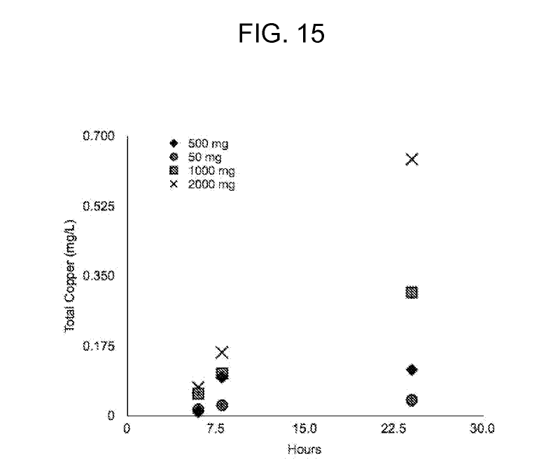

FIG. 16 graphically depicts associated energy dispersive spectroscopy (EDS) data for silver nanopatches identified on the ceramic surface of a tablet of FIG. 4.

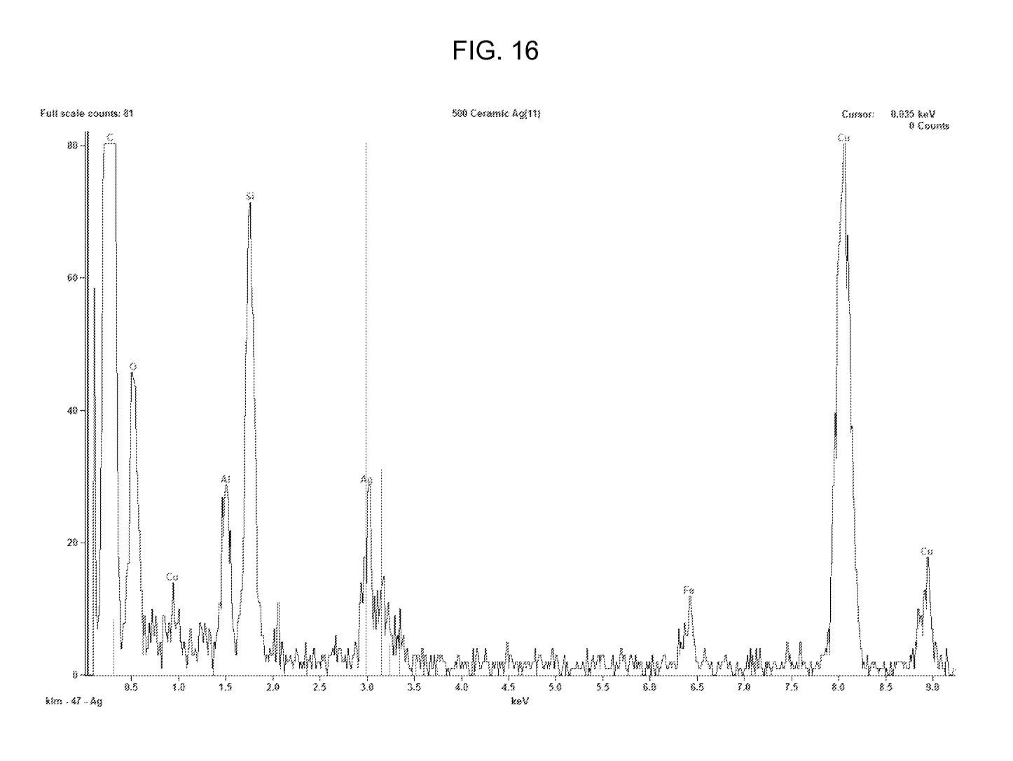

FIG. 17 represents a transmission electron microscopic image (TEM) of a MadiDrop made with sawdust and 500 mg of sliver nitrate. The circular marker indicates the location of where EDS data were collected (shown in FIG. 18).

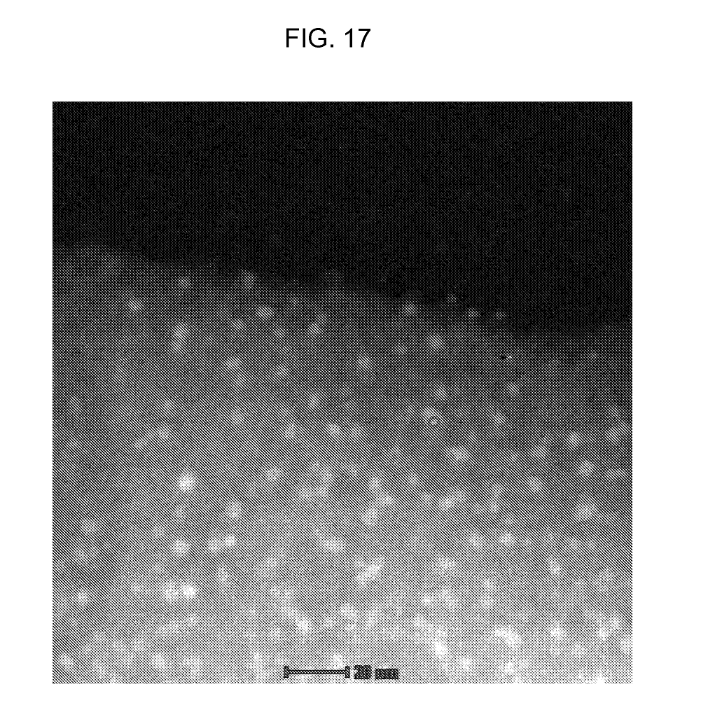

FIG. 18 graphically represents EDS data collected from the location indicated in FIG. 17.

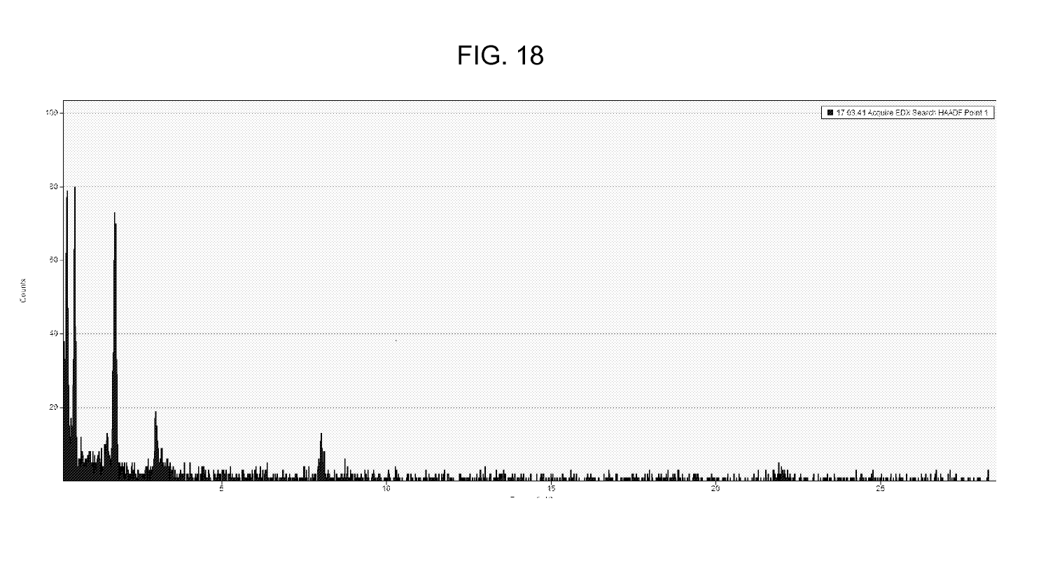

### DETAILED DESCRIPTION

Aspects of the invention include porous metal ceramic materials and methods of preparing the same. Also provided are methods of disinfecting a water source using the subject porous metal ceramic materials. Aspects of the invention further include compositions, e.g., materials, water treatment devices and kits, etc., that find use in methods of the invention. Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about”. The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Porous Metal Ceramic Materials

Aspects of the present invention relate to porous metal ceramic materials. The porous metal ceramic material may include a porous three-dimensional structure of sintered clay and metal nanopatches. As used herein, the term “sintered” refers to a material composed of particles that have been heated to a temperature under conditions sufficient to fuse the particles together and form a solid object.

In some embodiments, the material is a porous ceramic material comprising a three dimensional porous structure comprising sintered clay ceramic and metal nano-patches, wherein the metal nano-patches are distributed throughout the porous structure and exposed in the pores of the porous structure.

The metal nanopatch is a small area of material including zerovalent metal that is attached to the porous metal ceramic material. The metal nanopatch may be produced by sintering a mixture including clay and a metal ion-containing component (e.g., as described herein). In some cases, the metal nanopatch refers to a small area of a surface of the porous ceramic structure that is covered with the metal. The metal nano-patch may be located at any convenient locations in the ceramic material. The metal nano-patches may be distributed throughout the porous structure of the material, including at surface exposed locations and at buried locations. By surface exposed is meant exposed at the outer surface of the solid object and/or exposed at the inner surfaces of the pores of the porous structure. In some cases, the metal nanopatches are exposed in the pores of the porous structure such that water which passes through the pores of the material contacts the metal nanopatches.

Any convenient metals may be utilized in the subject metal nanopatches. Metals of interest include, but are not limited to, metals having one or more beneficial properties of interest when dissolved in water, such as bactericide properties, disinfectant properties, reducing properties, and the like. In certain embodiments, the tablet disinfects water that the tablet contacts. In certain embodiments, the filter disinfects water that passes through the filter.

The metal nanopatches may include a zerovalent metal, e.g., M⁰. In some cases, the metal nanopatches further include one or more metals having an oxidation states greater than zero, e.g., M¹⁺, M²⁺, M³⁺, etc. In certain cases, the metal nanopatches include alloys, or bimetallic materials such as coated metal particles. In some embodiments, the metal nano-patches comprise one or more metals selected from the group consisting of arsenic, cadmium, copper, gold, iron, mercury, silver, and zinc. In certain embodiments, the metal nano-patches comprise silver. In certain embodiments, the metal nano-patches comprise copper. In certain embodiments, the metal nano-patches comprise silver and copper.

In some embodiments, the porous ceramic material comprises one or more metals in an amount of between about 0.05% and about 5% by weight, such as about 0.05% and about 4% by weight, about 0.05% and about 3% by weight, about 0.05% and about 2% by weight, about 0.07% and about 2% by weight, about 0.09% and about 1% by weight. In certain embodiments, the porous ceramic material comprises one or more metals in an amount of between about 0.09% and about 1% by weight.

The porous structure of the metal ceramic material may be defined by a three-dimensional network of pores, channels, holes, and the like, in a solid object. The structures of the material, e.g., pores, channels, holes, etc., may have any convenient sizes, dimensions and arrangements, which may be selected as desired depending on the desired application and method of preparation. Any convenient methods of preparing a porous ceramic structure may be utilized. In some embodiments, the porous structure of the material is produced by the subject methods including use of a pore-forming agent (e.g., as described herein), where the locations of the pore-forming agent which may be removed during preparation defines the porous structure.

In some embodiments, the material includes nanostructures (e.g., nanopatches) having an average diameter of about 50 nm or less, such as about 40 nm or less, about 30 nm or less, about 20 nm or less, about 10 nm or less, or about 5 nm or less. In some embodiments, the material includes nanostructures having an average diameter of about 2 nm, about 3 nm, about 4 nm, about 5 nm, about 6 nm, about 7 nm, about 8 nm, about 9 nm, or about 10 nm. In certain embodiments, the material includes nanostructures ranging from about 3 nm to about 5 nm in diameter, e.g., as measured by a scanning electron microscope (SEM) or a transmission electron microscope (TEM).

In some embodiments, the porous structure of the porous ceramic material includes pores having an average diameter of about 300 um or less, such as about 200 um or less, about 100 um or less, about 80 um or less, about 60 um or less, about 40 um or less, about 30 um or less, about 20 um or less, about 10 um or less, about 5 um or less, about 2 um or less, or about 1 um or less. In some embodiments, the pores have an average diameter of about 1 um, about 3 um, about 6 um, about 8 um, about 10 um, about 15 um, about 20 um, about 25 um, or about 30 um. In certain embodiments, the material includes nanostructures ranging from about 1 um to about 30 um in diameter, e.g., as measured by a scanning electron microscope (SEM).

In some embodiments, the porous ceramic material has a porosity ranging between about 30% to about 50%, such as between about 35% to about 45%. In certain embodiments, the porous ceramic material has a porosity of about 10% or more, such as about 10%, about 15%, about 20%, about 25%, about 30%, about 35%, about 40%, about 45%, about 50%, about 55%, or about 60%.

In some embodiments, the porous structure that is formed is microporous, e.g., the material comprises a porous structure having pore sizes of about 1 μm to about 100 μm, such as about 1 μm to about 30 μm, about 1 μm to about 20 μm, or about 1 μm to about 10 μm. In certain embodiments, the porous structure has an average pore size of between about 1 μm and about 30 μm, such as between about 1 μm and about 15 μm, between about 1 μm and about 10 μm, or between about 1 μm and about 5 82 m. In certain embodiments, the porous structure has a % porosity of between about 50% and about 20%, such as between about 50% and about 30%, between about 45% and about 30%, or between about 45% and about 35%, and including between about 35% and about 40%, between about 40% and about 45%, and between about 45% and about 50%. In certain embodiments, the microporous structure has % porosity of about 35%, about 40%, or about 45%.

The material may be formed as a solid object of any convenient shape and size, such as the shape of a sphere, a cube, a donut, a disk, or other shapes, e.g., as described herein. In some embodiments, the porous metal ceramic material is a tablet. In one embodiment, surface area is increased by producing the solid object with such things in the surface as dimples, waffling, etc.

In some embodiments, the porous metal ceramic material is a filter. The porosity of the filter may be selected so as to provide for a desired flow-rate and contact time with the water. In some embodiments, the flow-rate is adjusted to change the contact time with water.

The porous ceramic material may be composed of any convenient ceramic materials. Ceramic materials of interest include those derived from a clay, including but not limited to, a halloysite, a kaolinite, an illite, a montmorillonite, a vermiculite, a talc, a palygorskite or a pyrophyllite. In one aspect, two or more clays are used. In some embodiments, porous ceramic material includes a clay ceramic such as an alumino-silicate.

In some embodiments, the clay ceramic is present in the porous metal ceramic material in an amount of about 20% or more by weight, such as about 30% or more, about 40% or more, about 50% or more, about 60% or more, about 70% or more, about 80% or more, about 90% or more, about 95% or more, or even about 99% by weight. In certain embodiments, the clay ceramic is present in the porous metal ceramic material in an amount of between about 40% and about 95% by weight, such as between about 50% and about 90% by weight, between about 50% and about 80% by weight, or between about 60% and about 80% by weight. In certain embodiments, the clay ceramic is present in the porous metal ceramic material in an amount of between about 50% and about 80% by weight.

Any convenient amount of metal may be included in a particular porous metal ceramic material object. The amount of metal present may be varied according to the desired application and the desired properties for the object, e.g., a desired capacity for delivering a bactericide or a disinfectant.

In some cases, the porous metal ceramic material includes one or more residual components from the mixture that was utilized in preparing the material, e.g., a biochar material as described below. In some embodiments, the porous metal ceramic material includes a residual amount of pore-forming agent, a residual amount of a metal ion-containing component, and/or a residual amount of a clay component. It is understood that such components may be present in the material without adversely affecting the properties of the material.

### Methods of Preparing

As summarized above, aspects of the invention include methods of preparing a porous ceramic material of interest. As such, aspects of the invention include heating a mixture of clay, a pore-forming agent and a metal ion-containing component under conditions sufficient to sinter the clay and the metal ion-containing component thereby forming a porous metal ceramic material (e.g., as described above).

As used herein, the terms “sinter”, “sintered”, and “sintering” refer to the process of heating a mixture of particles at a temperature sufficient to fuse the particles to each other to form a solid object. In some cases, the solid object has a porous three-dimensional structure. The sintering may be performed at any convenient temperature. In some cases, the sintering is performed at a temperature below the melting temperature of the components of the mixture. Any convenient sintering methods may be utilized in the subject methods. In some case, the heating is performed in a kiln.

In some embodiments, the method is a method of preparing a porous metal ceramic material, the method comprising: providing a mixture comprising a clay component, a pore-forming agent; and a metal ion-containing component; heating the mixture under conditions sufficient to sinter the clay component and the metal ion-containing component thereby forming a porous metal ceramic material.

The sintering of the clay component and the metal ion-containing component during the heating step of the method includes fusing the particles of the mixture together to form a solid object. In addition to fusing clay particles together, sintering of the mixture may lead to the formation of zerovalent metal nanopatches from the metal-ion containing component. In some cases, the sintering reduces all or part of the metal ion-containing component to zerovalent metal.

In some cases, the zerovalent metal nanopatches are fused to the clay particles as part of the porous structures produced. In certain cases, the zerovalent metal nanopatches are attached to the inner and/or outer surfaces of the porous ceramic structure.

In some embodiments, the material is a porous ceramic material comprising a three dimensional porous structure comprising sintered clay ceramic and metal nano-patches, wherein the metal nano-patches are distributed throughout the porous structure and exposed in the pores of the porous structure.

In some embodiments, the heating includes sintering, where the sintering is performed in the presence of oxygen. In certain embodiments, the sintering is performed in the absence of an additional reducing agent-containing component. In certain embodiments, the heating includes sintering which produces metal nanopatches.

In some embodiments, the heating of the mixture includes conditions sufficient to combust the pore-forming agent such that it is removed from the mixture thereby creating voids which define the porous structure of the product porous metal ceramic material. In some cases, heating is performed in the presence of oxygen to control and aid combustion. The presence and amount of oxygen present during the heating of the mixture may be controlled by any convenient method as needed to control any combustion of the pore-forming agent.

In some embodiments, the heating is performed at a temperature ranging from about 200 to about 1000° C., such as about 300 to about 900° C.

In some embodiments, the heating step includes heating the mixture at a first temperature for a first period of time, followed by heating at a second temperature for a second period of time. In certain embodiments, the first temperature ranges from about 100 to about 600° C., such as about 200 to about 600° C., about 300 to about 600° C., about 300 to about 500° C., about 300 to about 400° C., or about 300 to about 350° C. In certain cases, heating the mixture at the first temperature results in combustion of the pore-forming agent in the mixture. In certain cases, heating at the second temperature results in sintering of the mixture. In some embodiments, the sintering of the mixture is performed at a second temperature ranging from about 600 to about 1500° C., such as about 600 to about 1200° C., about 600 to about 1000° C., about 600 to about 900° C., about 700 to about 900° C., or about 800 to about 900° C.

Any convenient first and second periods of time may be selected for heating the subject mixtures, and may vary depending on the components of the mixture and the heating conditions. In some embodiments, the heating is maintained for a period of time of between about 2 hours and about 12 hours, such as about 4 hours and about 12 hours, or about 6 hours and about 10 hours. In certain embodiments, heating at the first temperature is maintained for a first period of about 2 to about 7 hours, such as about 3 to about 5 hours. In certain embodiments, heating at the second temperature is maintained for a second period of about 1 to about 5 hours, such as about 1 to about 3 hours, or about 1, 2, or 3 hours.

In certain embodiments, the presence and amount of oxygen may be controlled at both the first and second temperatures, and may be different as desired. For example, the amount of oxygen present while heating the mixture at the first temperature may be controlled to provide for a desired level of combustion of the pore-forming agent. For example, the amount of oxygen present while heating the mixture at the second temperature may be controlled to provide for a desired level of sintering of the mixture, and/or reduction of the metal-ion containing component.

Any convenient clays may be utilized as the clay component of the mixture. Clays of interest include, but are not limited to, commercial potter's clays, halloysite clays, kaolinite clays, illite clays, montmorillonite clays, vermiculite clays, talcs, palygorskite clays, pyrophyllite clays, alumino-silicate clays. In one aspect, two or more clays are used. In some embodiments, the clay is an alumino-silicate clay.

In some embodiments, the clay component is present in the mixture in an amount of about 20% or more by weight, such as about 30% or more, about 40% or more, about 50% or more, about 60% or more, about 70% or more, about 80% or more, about 90% or more, about 95% or more, or even about 99% by weight. In some embodiments, the clay component is present in the mixture in an amount of about 20% by weight or more, such as about 20%, about 30%, about 40%, about 50%, about 60%, about 70%, about 80%, about 90%, about 95% by weight. In certain embodiments, the clay component is present in the mixture in an amount of between about 40% and about 95% by weight, such as between about 50% and about 90% by weight, between about 50% and about 80% by weight, or between about 60% and about 80% by weight. In certain embodiments, the clay component is present in the mixture in an amount of between about 50% and about 80% by weight.

Any convenient metals and metal ions may be utilized in the subject methods and materials. Metals and metal ions of interest include, but are not limited to, metals and metal ions providing for one or more beneficial properties of interest when the product porous metal ceramic material are contacted with water, such as a bactericide properties, disinfectant properties, reducing properties, and the like. The metal ion-containing component may include any convenient metal ions. In some cases, the metal ion-containing component further include one or more metals having an oxidation states greater than zero, e.g., M¹⁺, M²⁺, M³⁺, etc. In certain cases, the metal ion-containing component comprise one or more metal ions selected from the group consisting of arsenic, cadmium, copper, gold, iron, mercury, silver and zinc ions. Any convenient counterions may also be included in the metal ion-containing component. In certain embodiments, the metal ion-containing component comprises silver ions, e.g., Ag⁺ ions. In certain embodiments, the metal ion-containing component comprises copper ions, e.g., Cu⁺ and/or Cu²⁺ ions. In certain embodiments, the metal ion-containing component comprises silver and copper ions. In some instances, the metal ion-containing component is silver nitrate. In certain instances, the metal ion-containing component is copper nitrate. In certain instances, the metal ion-containing component is copper sulfate.

In some embodiments, the metal ion-containing component is present in the mixture in an amount of about 1% or more by weight, such as about 5% or more, about 10% or more, about 15% or more, about 20% or more, about 25% or more, about 30% or more, about 35% or more, or even about 40% or more, by weight. In some embodiments, the metal ion-containing component is present in the mixture in an amount of about 1% by weight or more, such as about 1%, about 2%, about 3%, about 4%, about 5%, about 6%, about 7%, about 8%, about 9%, about 10%, about 15%, about 20%, about 25%, or about 30% by weight. In certain embodiments, the metal ion-containing component is present in the mixture in an amount of between about 2% and about 40% by weight, such as between about 5% and about 30% by weight, between about 10% and about 30% by weight, between about 10% and about 20% by weight, between about 20% and about 30% by weight, or between about 5% and about 20% by weight. In certain embodiments, the metal ion-containing component is present in the mixture in an amount of between about 10% and about 30% by weight.

In some embodiments, the metal ion-containing component is an aqueous solution. Any convenient additional components may be added to the aqueous solution, including but not limited to, pH regulating components, polymeric components, complexing agents, agents that facilitate mixing, and the like.

In some embodiments, the subject method further includes removing the pore-forming agent from the mixture. The pore-forming agent is capable of removal (e.g., combusting, melting dissolving or eroding away) from the mixture to produce a porous metal ceramic material that remains after heating. Application of suitable conditions, e.g., heating at a convenient temperature in the presence of oxygen, melting, or contact with an aqueous liquid, will remove the pore-forming agent. Exemplary conditions are set forth herein. For example, a molded mixture is heated in a kiln under conditions sufficient to combust the pore-forming agent in the mixture. For example, the pore-forming agent is contacted with a dissolving fluid and dissolves away thereby producing the pores that are formed in the material. In some embodiments, the pore-forming agent is removed from the mixture prior to sintering. In certain embodiments, the pore-forming agent is removed from the mixture during sintering. In some embodiments, the pore-forming agent is removed from the mixture after sintering.

In certain embodiments, the pore-forming agent may be removed by dissolution which is rapid, e.g., elution begins within about 60 minutes after immersion in dissolving fluid, such as within about 30 minutes, within about 15 minutes, within about 10 minutes, within about 5 minutes, or within about 2 minutes after immersion.

Any convenient pore-forming agents may be utilized in the subject methods and materials. Pore-forming agents of interest include solid agents and materials that are capable of removal from a clay mixture by any convenient method, e.g., by combustion, dissolution, evaporation, flushing, melting, etc. In some embodiments, the method further comprises removing the binder from the heterogeneous mixture. In some embodiments, the pore-forming agent is removed from the mixture via dissolution, evaporation, or flushing. In some embodiments, the pore-forming agent is removed from the mixture via combustion. In certain cases, the heating step includes combusting and removing the binder from the heterogeneous mixture.

Pore-forming agents of interest include, but are not limited to, an inorganic salt, a polymeric bead, an organic material such as sawdust, wood, paper, grain, rice husks, corn husks, cardboard, a carbohydrate, sugar, coffee grounds, any convenient cellulose material, a protein foaming agent (e.g., egg white protein), organic or polymeric beads, flour, etc. In some embodiments, the pore-forming agent is a particulate material and may be referred to as a particulate binder. In certain embodiments, the particulate binder is combustible. In certain embodiments, the particulate binder is removable via dissolution.

In some embodiments, the pore-forming agent is present in the mixture in an amount of about 1% or more by weight, such as about 2% or more, about 3% or more, about 4% or more, about 5% or more, about 10% or more, about 15% or more, about 20% or more, about 25% or more, or even about 30% by weight. In some embodiments, the pore-forming agent is present in the mixture in an amount of about 1% by weight or more, such as about 2%, about 3%, about 4%, about 5%, about 6%, about 7%, about 8%, about 9%, about 10%, about 15%, about 20%, about 25%, or about 30% by weight. In certain embodiments, the pore-forming agent is present in the mixture in an amount of between about 1% and about 40% by weight, such as between about 1% and about 30% by weight, between about 2% and about 20% by weight, between about 5% and about 20% by weight, between about 5% and about 10% by weight, or between about 10% and about 20% by weight. In certain embodiments, the pore-forming agent is present in the mixture in an amount of between about 5% and about 20% by weight.

In some embodiments, the ratio of clay to pore-forming agent in the heterogeneous mixture is between about 1:50 and about 1:1 by weight, such as between about 1:20 and about 1:2 by weight, between about 1:10 and about 1:5 by weight or between about 1:8 and about 1:6 by weight. In certain embodiments, the ratio of clay to pore-forming agent in the heterogeneous mixture is between about 1:10 and about 1:5 by weight.

Any convenient particle sizes may be utilized in the pore-forming agents that are composed of particles. In certain embodiments, the particulate binder has a mean diameter of about 1 μm to about 1 mm, such as about 1 μm to about 800 μm, about 1 μm to about 500 μm, about 1 μm to about 200 μm, about 1 μm to about 100 μm, about 1 μm to about 50 μm, about 1 μm to about 30 μm, about 1 μm to about 20 μm, or about 1 μm to about 10 μm. In certain embodiments, the particulate binder has an average particle diameter of between about 100 μm to about 1 mm, such as between about 100 μm and about 800 μm, between about 100 μm and about 500 μm, or between about 100 μm and about 300 μm. In certain embodiments, the particulate binder has an average diameter of between about 1 μm and about 30 μm, such as between about 1 μm and about 15 μm, between about 1 μm and about 10 μm, or between about 1 μm and about 5 μm.

Any one or more additional convenient components made be included in the subject methods and materials. Additional components of interest include, but are not limited to, pH-regulating components, pore-filling agents, polymeric coatings and the like. Such components may be added to the mixture prior to heating, or may be added to the porous metal ceramic material after heating. In some embodiments, the mixture further comprises a pH-regulating component. In some embodiments, the porous metal ceramic material further comprises a pH-regulating component.

In certain embodiments, the method further comprises coating the surfaces (e.g., outer and/or inner surfaces) of the porous metal ceramic material with a polymer.

In some cases, after sintering the porous structure of the material is filled with a pore-filling agent, e.g., a biocompatible and/or biodegradable agent that is capable of dissolution upon immersion in water. A suitable pore-filling agent may be selected in view of the composition of the porous metal ceramic material, and the desired elution profile or release rate of metal from the material. Any suitable water-soluble polymer or hydrogel may be used as a pore-filling agent. The pore-filling agent may be a naturally occurring agent or polymer or a synthetic agent or polymer. In some embodiments, the pore-filling agent is a water-soluble polymer such as a polyethylene glycol, a polyoxyethylene copolymer, an acrylate polymer, an acrylate-acrylic acid copolymer, a polyacrylic acid, an acrylate copolymer including quaternary ammonium groups, a polyacrylamide, a polyvinyl alcohol, hyaluronan, or a polyvinylpyrrolidone.

In some embodiments, the pore-filling agent is a carbohydrate, a protein or protein derivative, or the like. Exemplary pore-filling agents include, but are not limited to, gelatin, a polyethylene glycol (PEG), chitosan, polyvinylpyrrolidone (PVP), polyvinyl alcohol, or agarose. Any suitable PEG may be selected as a pore-filling agent.

In some instances, aspects of the method include providing a mixture comprising a clay component, a pore-forming agent, and a metal ion-containing component. The mixture may be prepared by combining the components of the mixture together in any convenient order, using any convenient methods. In some cases, the clay component and the pore-forming agent are first combined and mixed, prior to adding the metal-ion containing component. In some cases, the clay component and the metal-ion containing component are first combined and mixed, prior to adding the pore-forming agent. In certain instances, additional water or other convenient liquid may be added at any convenient step to facilitate mixing and/or molding. In some cases, the mixture is prepared such that the pore-forming agent and metal ion-containing component are uniformly distributed throughout the clay.

After mixing and/or molding, the mixture may then be dried to remove excess moisture prior to heating. In some cases, all components of the mixture are combined and mixed at the same time. In certain embodiments, the particulate binder is impregnated with or absorbs the aqueous solution in the mixture. In some embodiments, the method comprises: mixing the clay and the binder to produce a clay-binder mixture; contacting the clay-binder mixture with the aqueous solution to impregnate the binder in the mixture; and drying the mixture.

In certain embodiments, the method comprises: mixing the clay, the particulate binder, and an aqueous solution to produce a clay-binder mixture; shaping the clay-binder mixture into a desirable shape; drying the clay-binder mixture; and contacting the clay-binder mixture with the metal ion-containing component to coat the surface of the dried clay-binder mixture.

In some cases, the mixture is a mixture of particles, e.g., a mixture of clay particles and a particulate pore-forming agent (e.g., a particulate binder). In some embodiments, the mixture may be referred to as heterogeneous since the mixture contains particles.

The mixture may be shaped prior to sintering such that the solid object produced by the subject methods has a desired macroscopic shape. Objects of any convenient shapes and sizes may be produced in the subject methods by selection of a desirable form for the molded mixture. Any convenient methods of preparing the mixture to produce a desired shape and size of object may be utilized. In some cases, the mixture is molded. In some embodiments, the method further comprises molding the heterogeneous mixture into a pre-determined shape. In certain instances, the mixture is pressed into a mold under pressure. In some instances, the form of the molded mixture is further modified to include further structures, including but not limited to, macrostructures, microstructures, and nanostructures such as channels, pores, indents, holes, and the like. The pre-shaped mixture (e.g., as described above) may be dried prior to sintering.

### Water Treatment Devices

Also provided are water treatment devices. The water treatment device may include an object composed of the subject porous metal ceramic material. In some cases, the water treatment device includes a tablet (e.g., as described herein) that is located in a water reservoir of the device.

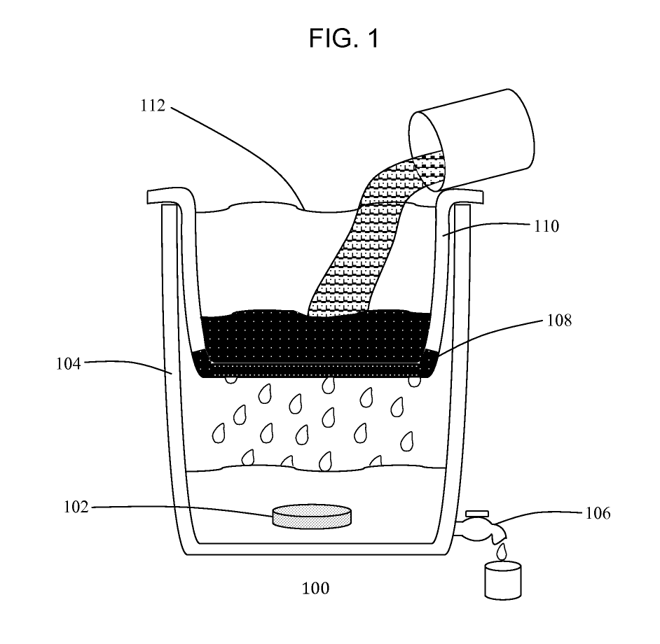

In some embodiments, the water treatment device includes a reservoir (e.g., 104, FIG. 1) comprising an inlet and an outlet (e.g., 106, FIG. 1); a porous metal ceramic tablet disposed in the reservoir (e.g., 102, FIG. 1); and an optional filter fluidically connected to the inlet of the reservoir. In some cases, the water treatment device includes a filter (e.g., as described herein). In some cases, water may be added to the reservoir of the device directly via the inlet without filtration. In other cases, water that is added to the reservoir of the device via the inlet is filtered through the filter.

Any convenient filters and filter materials may be utilized in the subject water treatment device. Filters of interest include, but are not limited to, a filter composed of porous metal ceramic material (e.g., as described herein), a carbon filter, a chromatography support, an ion exchange resin, a macroscopic particle filter, a membrane filter and a sand filter.

In some embodiments, the water treatment device further includes a first chamber (e.g., 110, FIG. 1) comprising a first inlet (e.g., 112, FIG. 1) and a first outlet (e.g., 108, FIG. 1) fluidically connected to the inlet of the reservoir, wherein the filter (e.g., 108, FIG. 1) is disposed in the fluid path between the first chamber (e.g., 110, FIG. 1) and the reservoir (e.g., 104, FIG. 1). In such cases, a volume of water may be added to the first chamber of the device and gravity filtration may occur to transfer filtered water from the first chamber to the reservoir of the device (see FIG. 1).

In some cases, the device includes a filter pot. Ceramic filter pots can be prepared utilizing the subject materials. A filter pot includes a first chamber, a filter, an inlet, and an outlet. In some cases there can be more than one inlet and more than one outlet. In some cases, the water treatment device includes a ceramic water filter composed of the subject porous metal ceramic material (e.g., as described herein).

In certain embodiments, the water treatment device includes a porous metal ceramic tablet that is produced by the subject methods (e.g., as described herein). In certain instances, the ceramic tablet is located in a lower water storage receptacle (e.g., a reservoir) of the device to provide residual disinfection during the water storage period. The tablet and/or filter of the device may include metal nanopatches that release a bactericide into water with which it comes in contact, thereby disinfecting the water. In some cases, the metal nanopatches of the tablet and/or filter release bactericide (e.g., a metal ion) into the water at a rate sufficient to maintain a bactericidal concentration of bactericide in the water of the reservoir, and which is also safe for human consumption. A bactericidal concentration is a concentration effective at reducing or eliminating bacteria in water. The bactericidal concentration may be further maintained at a level safe for human consumption.

In some embodiments, the bactericidal concentration of metal ions is maintained at a concentration of about 1 mg/mL or less, such as about 0.9 mg/mL or less, about 0.8 mg/mL or less, about 0.7 mg/mL or less, about 0.6 mg/mL or less, about 0.5 mg/mL or less, about 0.4 mg/mL or less, about 0.3 mg/mL or less, about 0.2 mg/mL or less, about 0.1 mg/mL or less, about 0.05 mg/mL or less, or about 0.01 mg/mL or less, about 0.001 mg/mL or less, about 0.0005 mg/mL or less, or about 0.0001 mg/mL or less, or about 0.00001 mg/mL or less. The bactericidal concentration of metal ions may vary depending on factors such as the bactericidal activity of the metal ions, the toxicity of the metals, and the like. It can also be varied according to the types of bacteria or pathogens known to be in the contaminated water. In certain embodiments, the bactericidal concentration of silver ions is maintained at a concentration of about 0.1 mg/mL or less. In certain embodiments, the bactericidal concentration of copper ions is maintained at a concentration of about 1.0 mg/mL or less. Any convenient methods may be utilized in determining the concentration of metal ions in water.

The dimensions and characteristics of the porous metal ceramic material object of the device may be selected according to a variety of factors, such as the volume of water that is to be treated, the length of treatment time, etc. In some embodiments, the tablet has a minimum surface area of about 50 cm² or more, such as about 60 cm² or more, about 70 cm² or more, about 80 cm² or more, about 90 cm² or more, about 100 cm² or more, or even more. In certain embodiments, the tablet has a minimum surface area of about 96 cm².

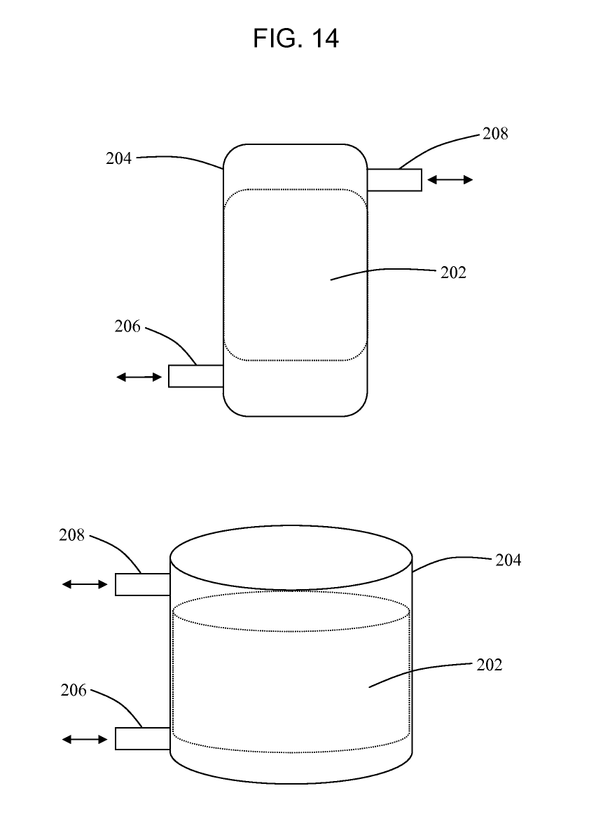

In some embodiments, the water treatment device is a device such as that depicted in FIG. 14. The water treatment device includes a chamber (e.g., 204, FIG. 14), a porous metal ceramic material (e.g., 202, FIG. 14) and two or more ports (e.g., 206 and 208, FIG. 14).

The porous metal ceramic material may be disposed in the chamber of the device. In some cases, the porous metal ceramic material completely fills the chamber such that any fluid that passes through the chamber flows through the porous structure of the material. In certain cases, the porous metal ceramic material is a tablet disposed at any convenient location in the chamber such that the tablet contacts a fluid added to the chamber. In some instances, the porous metal ceramic material is particulate such that the material may form a bed of material in the chamber. In certain instances, the chamber includes a frit or a filter disposed in the chamber at any convenient location.

The ports may be utilized to introduce and/or remove a fluid or a gas to the chamber. In some cases, the ports are used as an inlet port and an outlet port. In some instances, one or both of the ports may be fluidically connected to a pump system for facilitating the controlled flow of a fluid into and out of the chamber. In some embodiments, one of the ports may be connected to a gas source, e.g., for pressurizing the chamber. Utilizing the pump system, a fluid may be introduced into the chamber via either the first port or the second port. In certain cases, the fluid is circulated continuously through the chamber (e.g., in either direction) for a desired period of time utilizing the pump system. In some embodiments, gravity flow is utilized to flow fluid through the chamber via the first and second ports.

In some embodiments, the water treatment device may be utilized as a chromatography system, where the porous ceramic material is a chromatographic support that creates a bed of material through which the fluid flows. In such a system, any convenient ports may be configured and used as desired. In certain cases, the one or more of the ports is on the bottom of the chamber.

In some embodiments, the water treatment device may include an open top. In certain cases, the open top is utilized as a port. In certain embodiments, the water treatment device may be enclosed such that the chamber may be sealed, pressurized, and/or environment controlled, etc.

### Methods of Using

As summarized above, aspects of the invention include methods of using the subject porous ceramic materials (e.g., as described herein). Any of the subject porous ceramic materials and water treatment devices may be utilized in the subject methods of using. In some embodiments, the method is a method of disinfecting a water source, the method comprising: contacting the water source with the porous ceramic material (e.g., as described herein) under conditions sufficient to disinfect the water source.

In certain embodiments, the porous metal ceramic material is a tablet and contacting the water source comprises adding the tablet to a reservoir containing the water source. In some instances, the porous ceramic material is a filter and the water source is filtered through the filter. The porous metal ceramic material may release a bactericide into water with which it comes in contact, thereby disinfecting the water. In some cases, the contacting step includes release of a bactericide (e.g., a metal ion) from the metal nanopatches of the tablet and/or filter into the water at a rate sufficient to maintain a bactericidal concentration of bactericide in the water. This bactericidal concentration may be maintained at a level that is also safe for human consumption.

The subject methods may be used to remove a variety of bacteria and pathogenic microorganisms from a water source. In some embodiments, the bacteria is E. coli. Waterborne pathogens of interest include, but are not limited to, Norovirus, Rotavirus, Shigella, Vibrio cholerae, Cryptosporidium parvum, Giardia lamblia, and Entamoeba histolytica.

Any convenient water sources may be utilized in the subject methods. In some embodiments, the volume of water disinfected by a tablet utilizing the subject methods is of about 1 L or more, such as about 2 L, about 3 L, about 4 L, about 5 L, about 6 L, about 7 L, about 8 L, about 9 L, about 10 L, about 15 L, about 20 L, or even more. In some cases, the water is uncontaminated. In other cases, the water is contaminated with one or more bacteria or pathogenic microorganisms.

In some embodiments, the tablet includes sufficient metal to provide for disinfecting of the water over a period of from about 4 hours to about 1 week, such as from about 6 hours to about 3 days week, about 8 hours to about 2 days.

In some embodiments, the tablet is placed in a water storage container (e.g., a container of about 10 to about 20 L in volume) and disinfects the water after incubation overnight (e.g., after about 8 hours incubation). In some embodiment, the water container is refilled daily with contaminated water and the same tablet continues to disinfect water day after day for a period of time of about 1 week or more, such as about 2 weeks or more, 1 month or more, 2 months or more, 3 months or more, or 6 months or more, or 9 months or more, or 12 months or more.

In some embodiments, the method further comprises incubating a tablet with a volume of water, where a large amount of metal is released forming a high concentration of bactericide in the water (e.g., 2× or more than the minimum bactericidal concentration, such as 3×, 4×, 5×, 6×, 7×, 8×, 9×, 10× or more). In some instances, the water including such a high bactericidal concentration is aliquoted into smaller portions, where the aliquot can be added to a larger untreated volume of water to produce a desired bactericidal concentration in a reservoir of water.

### Utility

The materials, devices, kits and methods of the invention, e.g., as described herein, find use in a variety of applications. Applications of interest include, but are not limited to: research applications and water treatment applications. Methods of the invention find use in a variety of different applications including any convenient application where the treatment of water is of interest.

The subject materials and methods find use in a variety of water treatment applications. Water treatment applications of interest include those applications in which the consumption of safe drinking water and point of use water treatment is of interest. As such, the subject materials, devices, and methods find use in treatment of unsafe water from sources that include, for example, bacteria. In some instances, the compounds and methods are used to disinfect a source of water at a point of use. As demonstrated in FIG. 14 and described herein the compositions and methods of the invention are useful in devices that can be used for processing larger volumes of water on a large scale, and not just using single containers or buckets.

The subject compounds and methods find use in a variety of research applications. Research applications of interest include studying release of metal ions from sintered metal ceramic materials.

### Kits

Aspects of the invention further include kits, where the kits include one or more components employed in methods of the invention, e.g., tablets, filters, components, reagents, solvents, buffers, etc., as described herein. In some embodiments, the subject kit includes one or more components of the subject mixture (e.g., as described herein), and one or more additional components. Any of the components described herein may be provided in the kits. A variety of components suitable for use in making and using the subject materials and devices may find use in the subject kits.

In some embodiments, the kit comprising a clay and a metal ion-containing component. In some embodiments, the kit further comprising one or more components selected from a binder and instructions for use. In some embodiments, the kit further comprising one or more components selected from a binder and instructions for use.

In some embodiments, the metal ion-containing component comprises one or more metals selected from the group consisting of arsenic, cadmium, copper, gold, mercury, silver, and zinc. In certain embodiments, the metal ion-containing component comprises silver. In certain embodiments, the metal ion-containing component comprises silver nitrate. In certain embodiments, the metal ion-containing component comprises copper. In certain embodiments, the metal ion-containing component comprises copper nitrate. In certain embodiments, the metal ion-containing component comprises silver and copper.

In some embodiments, the clay is a halloysite, a kaolinite, an illite, a montmorillonite, a vermiculite, a talc, a palygorskite or a pyrophyllite. In certain embodiments, the clay is an aluminum silicate.

Kits may also include tubes, buffers, etc., and instructions for use. The various reagent components of the kits may be present in separate containers, or some or all of them may be pre-combined into a reagent mixture in a single container, as desired.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### EXPERIMENTAL

### General Method of Making the MadiDrop Tablet.

The following general methods may be adapted as convenient in preparing the subject materials.

1. MadiDrops are made using clay and sawdust making a dry mix (62.5 g) with a 9:1 to 5:1 ratio of clay to sawdust. The clay and sawdust are dried, ground, and sieved. The sawdust particles are optionally sieved through a 30 mesh, 20 mesh, 16 mesh or 12 mesh sieve prior to mixing. MadiDrops embedded with silver are made using 19.2 mL of silver nitrate solution instead of distilled water. The mix is molded in a 6.5-cm-diameter polyvinylchloride cylindrical mold and compressed for 1 minute at 1000 psi. The final width of the ceramic disk is 1.5 cm. The MadiDrops are air dried for 72 hours at room temperature and fired in a muffle furnace. The temperature for the furnace is increased at a rate of 150° C./hr from room temperature to 600° C., and then increased at a rate of 300° C./hr to 900° C., where it is held for 3 hours.

2. Sawdust is dried, ground, and passed through a 20-mesh sieve. 450 g of commercial, 200-mesh Redart pottery clay (Resco Products, Inc.) is combined with 50 g of the processed sawdust and mixed until homogeneous. 154 mL of H₂O containing either 0.6 g of AgNO₃ or 2 g of copper nitrate is added to the dry clay/sawdust and mixed until homogeneous.

The above-mentioned amounts of silver nitrate and copper nitrate can vary depending on the storage container the ceramic tablet is used for. If used in a 500-mL to 1-L water storage container, the amount of silver nitrate per disk would range between 0.16 g to 0.8 g silver nitrate per purifier (1.28 g to 6.4 g for a batch of 8). For a 20-L water storage container the amount of silver nitrate will range from 5 g to 15.7 g per purifier (40 g to 125.6 g for a batch of 8).

In some cases, 1 g of silver is used and 3× the amount of clay and sawdust.

For copper nitrate ceramic tablets, 1 g to 12.5 g of copper nitrate is embedded in each purifier (8 g to 100 g for batch of 8) for use with 500 mL to 1 L water storage containers. For 20 L water storage containers, a geometrically larger purifier is used with a range of 0.1 kg to 0.6 kg of copper nitrate per tablet (0.8 kg to 4.8 kg for 8 purifiers).

Silver nitrate and copper nitrate can also be combined in different proportions. Instead of using 1 g of silver nitrate, the tablet is fabricated with 0.6 g of silver nitrate and 0.4 g of copper nitrate.

The mixture is divided into eight batches of equal mass. Each batch is compressed at 1000 psi for 1 minute using a cylindrical mold. For a cylindrical mold, the diameter is 6.5 cm and the thickness is 1.5 cm.

The disks are air-dried for 72 hours at room temperature and humidity. The disks are then fired in a kiln. The kiln's temperature is increased at a rate of 150° C. per hour from room temperature to 600° C., and then increased at a rate of 300° C. per hour to 900° C., holding this final temperature for 3 hours. After cooling, the synthesis process is complete.

As noted above, different geometries are possible. The ceramic water purifier can be in the shape of a sphere, a cube, or other shapes. The surface area is at least 96 cm². Filter pots are made using the same methods and relative masses of water, sawdust, clay, and silver nitrate or copper nitrate.

As noted previously, the ceramic water purifiers can be used in combination with the ceramic water filters. The ceramic water purifier can be placed in the lower water storage receptacle of the ceramic water filter to provide residual disinfection during the water storage period.

### Method of Determining E. Coli Disinfection

Microbial disinfection analysis is done using IDEXX E. coli quantification methods. First, stocks of non-pathogenic E. coli are prepared by culturing E. coli (IDEXX Laboratories (cat. 982900700, Lot 042313)). The IDEXX E. coli is thawed at room temperature for 10-15 minutes and then transferred to 100 mL of sterilized Luria-Bertani (LB) broth. LB broth is made with 0.5 g yeast extract, 0.5 g sodium chloride, 0.25 g Bacto-Tryptone, and 50 mL deionized water. The IDEXX E. coli culture is slightly mixed and allowed to stand at room temperature for an additional 15 minutes. The bacteria culture is then transferred to 6 mL of LB broth and incubated at 37° C. for 12 hours in a VWR Scientific Orbital Shaker (Model 980001) at 0.426×g. Then, 150 μL of the bacteria culture is aliquoted in sterilized centrifuge tubes with 150 μL of 40% glycerol and stored at −20° C.

For each experiment, E. coli culture is prepared from the frozen stock. Bacteria are thawed at room temperature for approximately 5 minutes, from which 50 μL was added to 50 mL of sterilized LB broth. E. coli is cultured for 12 hours in a shaking incubator at 37° C. and 0.426×g. After incubation, the bacterial culture is centrifuged for 20 minutes at 1363×g using a Thermo Fisher Scientific Laboratory Centrifuge (Model Sorvall Legend XTR). The culture is resuspended in 50 mL of 10 mM phosphate buffer (PB) solution and stored at 4° C. for up to 5 days. The PB solution is used to preserve viability of E. coli in water while preventing growth. The PB solution is made with 112 g/L of dipotassium phosphate, 48 g/L of potassium phosphate monobasic, 0.2 g/L of Ethylenediamenetetraacetic acid and deionized water. Sodium thiosulfate is also used in microbial testing to stop the disinfection of silver. A 60 g/L solution of sodium thiosulfate is prepared by dissolving anhydrous sodium thiosulfate (Fisher Scientific, cat. 7772-98-7) in deionized water. For every sample, 26.4 μL of 60 g/L sodium thiosulfate is added per 1 mL of sample and then incubated at room temperature for 2 minutes. All solutions used in microbial analysis are sterilized in an autoclave before being used.

### Microbial Disinfection Experiments.

Samples were spiked with known amounts of the cultured E. coli. Then the appropriate ceramic disk was placed in each sample container. Samples were taken at 4, 6, 8, and 24 hours to measure levels of viable E. coli. Each sample was treated with sodium thiosulfate to stop the disinfection caused by silver ions (26.4 μL per 1 mL of sample). Viable E. coli were quantified in each sample using the Colilert Defined-Substrate Technology System. Colilert-18 reaction packets (cat. WP200I-18) were added to 100 mL of the sample and mixed thoroughly. The solution was poured into the IDEXX Quanti-trays (cat. WQT-2K) and incubated for 24 hours at 37° C. Using a UV-vis lamp, the number of the wells that fluoresced were counted and correlated to E. coli concentrations using a most-probably-number table provided by IDEXX.

Method of Determining Metal and Metal Ions Released into Water

Both ionic and total silver concentrations are measured at 4, 6, 8, and 24 hours. Ionic silver is measured using a Thermo Scientific Orion Ion Selective Electrode (ISE) for silver/sulfide ions. Samples and standards are prepared with 1 mL of low ionic strength adjuster solution (Thermo Scientific, cat. 940011) for every 100 mL of sample. Samples analyzed for total silver concentration are prepared with nitric acid (1%) to reduce chelation of ions. These measurements are made using an acetylene-air flame atomic absorption (AA) spectrometer (Perkin-Elmer model AA2100) with a multi-element hollow cathode lamp. For both methods, standard silver solutions are prepared using anhydrous silver nitrate (Acros Organics, cat. 7761-88-8).

Methods which may be adapted for use in the preparation of the subject materials and devices include those described by Kallman, E., V. Oyanedel-Craver, and J. A. Smith (Ceramic filters impregnated with silver nanoparticles for point-of-use water treatment in rural Guatemala. Journal of Environmental Engineering, 2011, 137(6): p. 407-415); Oyanedel-Craver, V. and J. A. Smith (Sustainable colloidal-silver-impregnated ceramic filter for point-of-use water treatment. Environmental Science and Technology, 2008. 42(3): p. 927-933); and Abebe, L. S.; Smith, J. A.; Narkiewicz, S.; Oyanedel-Craver, V.; Conaway, M.; Singo, A.; Samie, A.; Brant, J.; Dillingham, R. (Ceramic water filters impregnated with silver nanoparticles as a point-of-use water-treatment intervention for HIV-positive individuals in Limpopo Province, South Africa: A pilot study of technological performance and human health benefits. Journal of Water and Health 2012), the disclosures of which are herein incorporated by reference in their entirety.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Headings are included herein for reference and to aid in locating certain sections. These headings are not intended to limit the scope of the concepts described therein under, and these concepts may have applicability in other sections throughout the entire specification.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method of preparing a porous metal ceramic material, the method comprising:
providing a mixture comprising:
a clay;
a pore-forming agent; and
a metal ion-containing component;
heating the mixture under conditions sufficient to sinter the clay and the metal ion-containing component thereby forming a porous metal ceramic material.

2. The method according to claim 1, further comprising removing the pore-forming agent from the mixture.

3. The method according to claim 1, wherein the heating combusts and removes the pore-forming agent from the mixture.

4. The method according to claim 3, wherein the pore-forming agent is removed from the mixture via dissolution, evaporation, or flushing.

5. The method according to claim 1, wherein the pore-forming agent is a particulate binder.

6. The method according to claim 5, wherein the particulate binder is composed of a combustible material.

7. The method according to claim 1, further comprising molding the mixture into a pre-determined shape.

8. The method according to claim 1, wherein the heating is performed in the presence of oxygen.

9. The method according to claim 1, wherein the heating is performed in the absence of an additional reducing agent-containing component.

10. The method according to claim 1, wherein the heating is performed at a temperature ranging from about 200 to about 1000° C.

11. The method according to claim 10, wherein the heating is maintained for a period of time of between about 2 hours and about 12 hours.

12. The method according to claim 1, wherein the heating comprises heating the mixture at a first temperature ranging from about 300 to about 600° C. to combust and remove the pore-forming agent from the mixture.

13. The method according to claim 12, wherein the heating further comprises heating the mixture at a second temperature ranging from about 600 to about 1000° C.

14. The method according to claim 1, wherein the heating reduces the metal ion-containing component.

15. The method according to claim 1, wherein the heating produces metal nanopatches.

16. The method according to claim 1, wherein the heating is performed in a kiln.

17. The method according to claim 1, wherein the metal ion-containing component is an aqueous solution.

18. The method according to claim 1, wherein the pore-forming agent is impregnated with the aqueous solution.

19. The method according to claim 16, wherein the method comprises:
mixing the clay and the pore-forming agent to produce a first mixture;
contacting the clay-binder mixture with the aqueous solution to produce a second mixture; and
drying the second mixture.

20. The method according to claim 1, wherein the method comprises:
mixing the clay, the pore-forming agent, and an aqueous solution to produce a first mixture;
shaping the first mixture into a desirable shape;
drying the first mixture;
contacting the first mixture with the metal ion-containing component to coat the surface of the first mixture.

21. The method according to claim 1, wherein the metal ion-containing component comprises one or more metals selected from the group consisting of arsenic, cadmium, copper, gold, iron, mercury, silver, and zinc.

22. The method according to claim 21, wherein the metal ion-containing component comprises silver.

23. The method according to claim 22, wherein the metal ion-containing component is silver nitrate.

24. The method according to claim 21, wherein the metal ion-containing component comprises copper.

25. The method according to claim 24, wherein the metal ion-containing component is copper nitrate.

26. The method according to claim 21, wherein the metal ion-containing component comprises silver and copper.

27. The method according to claim 1, wherein the clay is a halloysite, a kaolinite, an illite, a montmorillonite, a vermiculite, a talc, a palygorskite, or a pyrophyllite.

28. The method according to claim 1, wherein the clay is an alumino-silicate clay.

29. The method according to claim 1, wherein the clay component is present in the heterogeneous mixture in an amount of between about 50% and about 80% by weight.

30. The method according to claim 5, wherein the binder component is present in the heterogeneous mixture in an amount of between about 5% and about 20% by weight.

31. The method according to claim 1, wherein the metal ion-containing component is present in the heterogeneous mixture in an amount of between about 10% and about 30% by weight.

32. The method according to claim 1, wherein the porous ceramic material comprises one or more metals in an amount of between about 0.09% and about 1% by weight.

33. The method according to claim 1, wherein the ratio of clay to binder in the heterogeneous mixture is between about 1:10 and about 1:5 by weight.

34. The method according to claim 1, further comprising coating the surfaces of the porous metal ceramic material with a polymer.

35. The method according to claim 1, wherein the mixture further comprises a pH-regulating component.

36. A porous ceramic material produced by the method of claim 1.

37. The porous ceramic material according to claim 36, wherein the material comprises a porous ceramic structure and metal nanopatches, wherein the metal nanopatches are distributed throughout the porous structure and exposed in the pores of the porous structure.

38. The porous ceramic material according to claim 36, wherein the material is a tablet.

39. The porous ceramic material according to claim 36, wherein the tablet disinfects water that the tablet contacts.

40. The porous ceramic material according to claim 36, wherein the tablet disinfects water that the tablet contacts.

41. The porous ceramic material according to claim 36, wherein the material is a filter.

42. The porous ceramic material according to claim 36, wherein the material has a porosity of between about 20% and about 0.01%.

43. The porous ceramic material according to claim 41, wherein the filter disinfects water that passes through the filter.

44. A porous ceramic material comprising a three-dimensional porous structure comprising hardened clay ceramic and metal nanopatches, wherein the metal nanopatches are distributed throughout the porous structure and exposed in the pores of the porous structure.

45. The porous ceramic material according to claim 44, wherein the porous ceramic material has a porosity of about 30% to about 60%.

46. The porous ceramic material according to claim 44, wherein the metal nanopatches comprise one or more metals selected from the group consisting of arsenic, cadmium, copper, gold, iron, mercury, silver, and zinc.

47. The porous ceramic material according to claim 46, wherein the metal nanopatches comprise silver.

48. The porous ceramic material according to claim 46, wherein the metal nanopatches comprise copper.

49. The porous ceramic material according to claim 46, wherein the metal nanopatches comprise silver and copper.

50. The porous ceramic material according to claim 42, wherein the clay ceramic is a halloysite, a kaolinite, an illite, a montmorillonite, a vermiculite, a talc, a palygorskite or a pyrophyllite.

51. The porous ceramic material according to claim 44, wherein the clay ceramic is an alumino-silicate.

52. The porous ceramic material according to claim 44, wherein the clay ceramic is present in an amount of between about 45% and about 95% by weight.

53. The porous ceramic material according to claim 44, wherein the metal nanopatches are present in an amount of between about 0.05% and about 5% by weight.

54. The porous ceramic material according to claim 44, wherein the material is a tablet.

55. The porous ceramic material according to claim 44, wherein the material is a filter.

56. The porous ceramic material according to claim 44, wherein the material has a porosity of between about 20% and about 0.01%.

57. The porous ceramic material according to claim 44, wherein the material disinfects water.

58. A method of disinfecting a water source, the method comprising:
contacting the water source with the porous ceramic material of claim 44 or claim 36 under conditions sufficient to disinfect the water source.

59. The method according to claim 58, wherein the porous ceramic material is a tablet and contacting the water source comprises adding the tablet to a reservoir containing the water source.

60. The method according to claim 58, wherein the porous ceramic material is a filter and the water source is filtered through the filter.

61. A kit comprising a clay and a metal ion-containing component.

62. The kit according to claim 61, further comprising one or more components selected from a pore-forming agent and instructions for use.

63. The kit according to claim 61, wherein the metal ion-containing component comprises one or more metals selected from the group consisting of arsenic, cadmium, copper, gold, mercury, silver, and zinc.

64. The kit according to claim 61, wherein the metal ion-containing component comprises silver.

65. The kit according to claim 64, wherein the metal ion-containing component comprises silver nitrate.

66. The kit according to claim 61, wherein the metal ion-containing component comprises copper.

67. The kit according to claim 66, wherein the metal ion-containing component comprises copper nitrate.

68. The kit according to claim 61, wherein the metal ion-containing component comprises silver and copper.

69. The kit according to claim 61, wherein the clay is a halloysite, a kaolinite, an illite, a montmorillonite, a vermiculite, a talc, a palygorskite, or a pyrophyllite.

70. The kit according to claim 61, wherein the clay is an aluminum silicate.

71. A water treatment device, comprising:
a reservoir comprising an inlet and an outlet;
a porous metal ceramic tablet disposed in the reservoir; and
an optional filter fluidically connected to the inlet of the reservoir.

72. The water treatment device of claim 71, further comprising a first chamber comprising a first inlet and a first outlet fluidically connected to the inlet of the reservoir, wherein the filter is disposed in the fluid path between the first chamber and the reservoir.

73. The water treatment device of claim 71, wherein the filter is selected from a carbon filter, a chromatography support, an ion exchange resin, a macroscopic particle filter, a membrane filter, and a sand filter.

74. The water treatment device of claim 71, wherein the porous metal ceramic tablet is produced by the method of claim 1.
